(19) United States
(12) Patent Application Publication
(10) Pub. No.: US 2026/0259118 A1
(43) Pub. Date: Sep. 3, 2026

(54) LARGE-SIZE FULLY-GRADED CONCRETE AXIAL TENSION SPECIMEN, MANUFACTURING MOLD, TESTING DEVICE AND TESTING METHOD

(71) Applicant: Zhengzhou University, Zhengzhou (CN)

(72) Inventors: Shaowei HU, Zhengzhou (CN); Yaoqun XU, Zhengzhou (CN); Yuxiao YE, Zhengzhou (CN); Chengcheng WEN, Zhengzhou (CN); Jinghao LI, Zhengzhou (CN); Chaozhong LI, Zhengzhou (CN)

(73) Assignee: Zhengzhou University, Zhengzhou (CN)

(21) Appl. No.: 19/209,845

(22) Filed: May 16, 2025

(30) Foreign Application Priority Data
Mar. 3, 2025 (CN) 202510245619.7

(51) Int. Cl. G01N 3/08; G01N 1/36

(52) U.S. Cl. CPC G01N 3/08; G01N 1/36; G01N 2001/366; G01N 2203/0017

(57) ABSTRACT

A large-size fully-graded concrete axial tension specimen, a manufacturing mold, a testing device and a testing method are provided. The specimen includes: a specimen body formed by casting fully-graded concrete; two embedded steel plates, where the two embedded steel plates are embedded in the specimen body, and the two embedded steel plates are arranged in parallel and opposite to each other; two embedded threaded rods, where the two embedded threaded rods are arranged in one-to-one correspondence with the two embedded steel plates, one end of the embedded threaded rods is fixedly connected to a corresponding embedded steel plate, and another end extends to an outer side of the specimen body.

This application is based upon and claims priority to Chinese Patent Application No. 202510245619.7, filed on March 3, 2025, the entire contents of which are incorporated herein by reference.

### TECHNICAL FIELD

The present invention belongs to the test technical field of mechanical properties of dam concrete, and particularly relates to a large-size fully-graded concrete axial tension specimen, a manufacturing mold, a testing device and a testing method.

### BACKGROUND

In the field of water conservancy projects, the concrete material for casting dams is mostly fully-graded concrete with a maximum aggregate size of 150 mm. According to the principles of concrete testing, a minimum boundary size of the specimen should not be less than 3 times the maximum aggregate size, that is, 450 mm. Therefore, a size of a specimen for the mechanical property test of fully-graded concrete is huge, and there are technical difficulties such as test difficulties and inconsistent test methods.

Dam concrete is generally subjected to high tensile stress during long-term service. The test technology for axial tension performance test of fully-graded concrete has become an important issue in evaluating and predicting the service form and life of dam concrete. Therefore, there is an urgent need for a testing device and method that can accurately test an axial tension constitutive relationship of fully-graded concrete.

### SUMMARY

To provide a testing device and method that can accurately test an axial tension constitutive relationship of fully-graded concrete, the present invention adopts the following technical solutions:

A large-size fully-graded concrete axial tension specimen includes:

a specimen body formed by casting fully-graded concrete;

two embedded steel plates, wherein the two embedded steel plates are embedded in the specimen body, and the two embedded steel plates are arranged in parallel and opposite to each other; and

two embedded threaded rods, wherein the two embedded threaded rods are arranged in one-to-one correspondence with the two embedded steel plates, one end of one of the embedded threaded rods is fixedly connected to a corresponding embedded steel plate, and another end extends to an outer side of the specimen body.

Further, a size of the specimen body is 450 mm×450 mm×900 mm.

Further, a center line of the specimen body in a length direction, a normal center line of the embedded steel plate and a center axis of the embedded threaded rod are collinear.

A manufacturing mold for a large-size fully-graded concrete axial tension specimen is used to manufacture the large-size fully-graded concrete axial tension specimen according to any one of the foregoing aspects, and includes:

a slab;

two edge side plates oppositely arranged, wherein the two edge side plates are respectively arranged at edges of the slab in a width direction, and one end of each edge side plate close to the slab is fixedly connected to the slab by a slab fixing bolt;

two bottom side plates oppositely arranged, wherein the two bottom side plates are respectively fixedly mounted at edges of the slab in a length direction and enclose a casting space with an open end together with the slab and the two edge side plates;

the two bottom side plates are fixedly connected to the slab by slab fixing bolts, and the two ends of the bottom side plates are fixedly connected to the two edge side plates by side plate fixing screws and nuts; and the bottom side plates are provided with reserved holes adapted to the embedded threaded rods.

Further, the bottom side plate is fixedly connected to the two edge side plates by two side plate fixing screws, the two side plate fixing screws are arranged in parallel, and two ends of each side plate fixing screw sequentially pass through a connecting flange of the bottom side plate and a corresponding edge side plate to cooperate with the nut; and a through hole on the bottom side plate adapted to the embedded threaded rod is arranged between the two side plate fixing screws.

A large-size fully-graded concrete axial tension performance testing device is used for axial tension performance test of the large-size fully-graded concrete axial tension specimen according to any one of the foregoing aspects, and includes:

a loading base, wherein the loading base is fixed on a rigid base by a base fixing bolt; a base ball joint is embedded in a center of the loading base, and a connecting rod of the base ball joint extends to an outer side of the loading base and is in threaded connection with an embedded threaded rod of the large-size fully-graded concrete axial tension specimen;

a combined sleeve, wherein a first end of the combined sleeve is in threaded connection with another embedded threaded rod of the large-size fully-graded concrete axial tension specimen;

a load sensor, wherein the load sensor is connected to a second end of the combined sleeve;

a tensile ball joint, wherein a ball seat of the tensile ball joint is connected to the load sensor, and a connecting rod of the tensile ball joint is connected to a tensile testing machine;

a displacement meter mounting frame, wherein the displacement meter mounting frame is sleeved on an outer side of the specimen body and is clamped and fixed on the specimen body by tightening bolts of the displacement meter mounting frame; and

a displacement meter, wherein the displacement meter is mounted on the displacement meter mounting frame.

Further, the large-size fully-graded concrete axial tension performance testing device further includes a protective bracket, wherein the protective bracket is sleeved outside the connecting rod of the base ball joint and is fixedly connected to the loading base.

A large-size fully-graded concrete axial tension performance testing method includes the following steps:

S10: assembling the foregoing manufacturing mold for a large-size fully-graded concrete axial tension specimen, and placing the manufacturing mold in a casting and molding area of a large-size fully-graded concrete axial tension specimen;

S20: welding an embedded steel plate and an embedded threaded rod to form an embedded part, and placing the embedded part in the manufacturing mold for a large-size fully-graded concrete axial tension specimen, wherein the embedded threaded rod passes through a reserved hole in a bottom side plate;

S30: casting fully-graded concrete into the manufacturing mold for the large-size fully-graded concrete axial tension specimen, dismantling the manufacturing mold for a large-size fully-graded concrete axial tension specimen after curing for 3 days, and then curing to a testing age to form the large-size fully-graded concrete axial tension specimen according to claims 1 to 3;

S40: fixing a loading base in the foregoing large-size fully-graded concrete axial tension performance testing device on a rigid base by a base fixing bolt; mounting a protective bracket on the loading base, and mounting a combined sleeve on one end of the large-size fully-graded concrete axial tension specimen embedded with a threaded rod at one side; hoisting a large-size fully-graded concrete axial tension specimen by the combined sleeve, and mounting a threaded steel rod embedded at another end of the large-size fully-graded concrete axial tension specimen into a central threaded hole of a base ball joint; wherein an upper part of the combined sleeve is connected to a load sensor, an upper part of the load sensor is connected to a tensile ball joint, and an upper part of the tensile ball joint is connected to a tensile testing machine; and

S50: starting the tensile testing machine to start fully-graded concrete axial tension performance test, and acquiring a load-displacement curve in the test process by a load sensor and a displacement meter to further acquire a stress-strain relationship curve of the fully-graded concrete axial tension performance test.

Further, the assembling the manufacturing mold for a large-size fully-graded concrete axial tension specimen in the step S10 includes the following steps:

S11: placing a slab in a casting and molding area of the large-size fully-graded concrete axial tension specimen;

S12: fixing a bottom side plate and edge side plates on the slab by bolts; fixing the two edge side plates by using side fixing bolts, and screwing the bolts to press and fix the bottom side plate between the two edge side plates;

in the step S20, a distance between the embedded steel plate and the bottom side plate at a corresponding side is 150 mm.

### Beneficial Effects

With the cooperative optimization of the mold, the specimen, the device and the method, the present invention solves the technical problem of large-size fully-graded concrete axial tension test, achieves the high-precision and high-safety axial tension performance evaluation, provides a scientific basis for the prediction of the service life of concrete in water conservancy projects such as dams, and has significant engineering practical value.

### BRIEF DESCRIPTION OF THE DRAWINGS

FIG. 1 is a schematic diagram of a structure of a large-size fully-graded concrete axial tension specimen according to the present invention;

FIG. 2 is a schematic diagram of a structure of a mold for a large-size fully-graded concrete axial tension specimen according to the present invention; and

FIG. 3 is a schematic diagram of a structure of a large-size fully-graded concrete axial tension performance testing device according to the present invention.

Reference numerals: 1: bottom side plate; 2: embedded steel plate; 3: embedded threaded rod; 4: edge side plate; 5: side plate fixing screw; 6: slab fixing bolt; 7: slab; 8: tensile ball joint; 9: load sensor; 10: combined sleeve; 11: displacement meter; 12: specimen body; 13: displacement meter mounting frame; 14: protective bracket; 15: base ball joint; 16: loading base; and 17: base fixing bolt.

### DETAILED DESCRIPTION OF THE EMBODIMENTS

### Embodiment 1

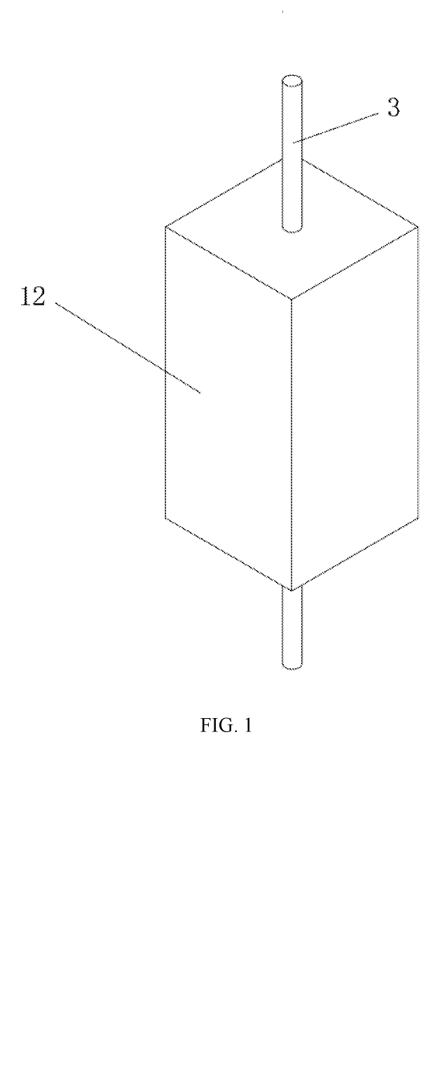

Referring to FIG. 1, a large-size fully-graded concrete axial tension specimen includes:

a specimen body formed by casting fully-graded concrete;

two embedded steel plates 2, wherein the two embedded steel plates 2 are embedded in the specimen body 12, and the two embedded steel plates 2 are arranged in parallel and opposite to each other; and

two embedded threaded rods 3, wherein the two embedded threaded rods 3 are arranged in one-to-one correspondence with the two embedded steel plates 2, one end of one of the embedded threaded rods 3 is fixedly connected to a corresponding embedded steel plate 2, and another end extends to an outer side of the specimen body 12.

In this embodiment, a size of the specimen body 12 is 450 mm×450 mm×900 mm.

In this embodiment, a center line of the specimen body 12 in a length direction, a normal center line of the embedded steel plate 2 and a center axis of the embedded threaded rod 3 are collinear.

In this embodiment, the embedded threaded rod 3 is preferably a threaded steel rod, and a specification of the threaded steel rod is an M33 embedded threaded steel rod.

Specifically, the embedded steel plates 2 are symmetrically embedded inside two ends of the specimen body 12, the embedded steel plates 2 are welded to the embedded threaded rod 3 as a whole, the embedded threaded rod 3 extends out of the specimen body 12, that is, the two embedded threaded rods 3 are symmetrically arranged at two ends of the specimen body 12 for axial tensile loading.

The large-size fully-graded concrete axial tension specimen provided in this embodiment has the following technical effects:
(1) The design of the specimen size of 450 mm×450 mm×900 mm meets the requirement of 3 times of a size of a maximum aggregate diameter of 150 mm, and the test result can reflect the actual performance of fully-graded concrete.
(2) The embedded threaded steel rod and the steel plate are welded into a whole, and a specimen extends out, which can simplify the mounting process and improve the stability of the loading connection, thus avoiding stress concentration or data distortion caused by embedded offset of traditional specimens.

### Embodiment 2

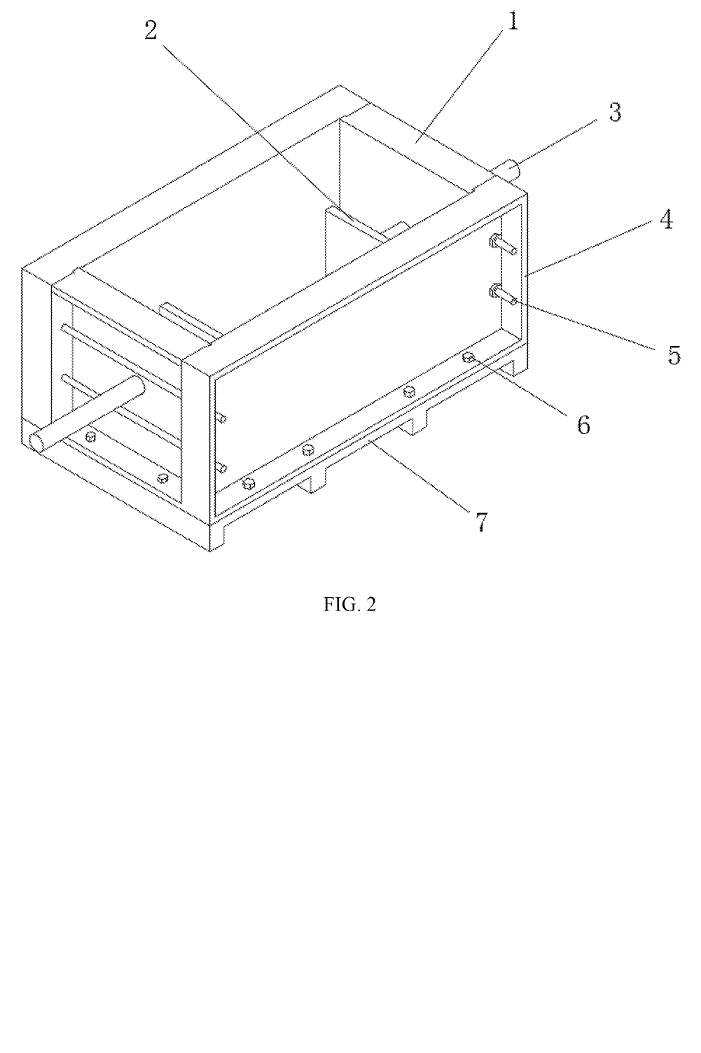

Referring to FIG. 2, a manufacturing mold for a large-size fully-graded concrete axial tension specimen is used to manufacture the large-size fully-graded concrete axial tension specimen provided in Embodiment 1, and includes:

a slab 7;

two edge side plates 4 oppositely arranged, wherein the two edge side plates 4 are respectively arranged at edges of the slab 7 in a width direction, and one end of each edge side plate 4 close to the slab 7 is fixedly connected to the slab 7 by a slab fixing bolt 6;

two bottom side plates 1 oppositely arranged, wherein the two bottom side plates 1 are respectively fixedly mounted at edges of the slab 7 in a length direction and enclose a casting space with an open end together with the slab 7 and the two edge side plates 4;

the two bottom side plates 1 are fixedly connected to the slab 7 by slab fixing bolts 6, and the two ends of the bottom side plates 1 are fixedly connected to the two edge side plates 4 by side plate fixing screws 5 and nuts; and the bottom side plates 1 are provided with reserved holes adapted to the embedded threaded rods 3.

Specifically, the slab fixing bolt 6 is an M16 high-strength bolt.

In this embodiment, the bottom side plate 1 is fixedly connected to the two edge side plates 4 by two side plate fixing screws 5, the two side plate fixing screws 5 are arranged in parallel, and two ends of each side plate fixing screw 5 sequentially pass through a connecting flange of the bottom side plate and a corresponding edge side plate 4 to cooperate with the nut; and a through hole on the bottom side plate 1 adapted to the embedded threaded rod 3 is arranged between the two side plate fixing screws 5.

Specifically, the side plate fixing screw is an M16 high-strength screw cooperating with an M16 nut for use.

In this embodiment, a distance between the embedded steel plate 2 and the bottom side plate 1 at a corresponding side is 150 mm.

The manufacturing mold for a large-size fully-graded concrete axial tension specimen provided in this embodiment adopts a modular design, which is easy to disassemble and reuse and reduce mold loss.

### Embodiment 3

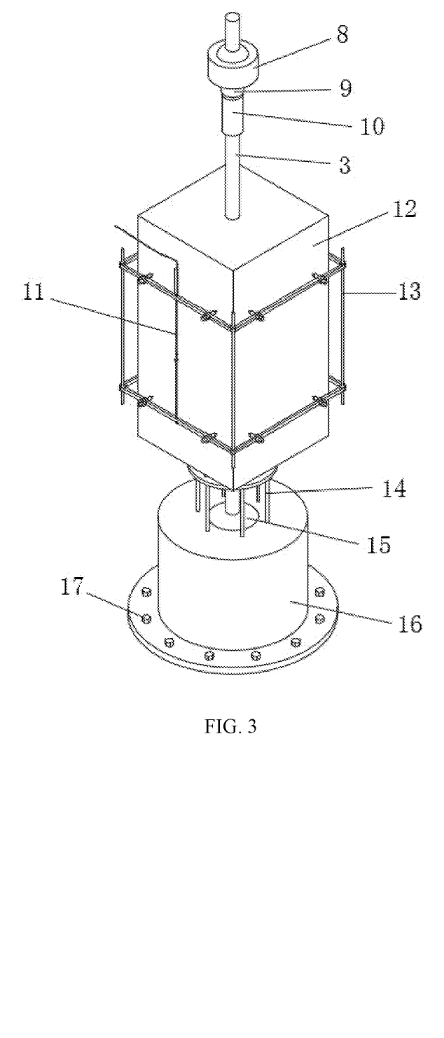

Referring to FIG. 3, a large-size fully-graded concrete axial tension performance testing device is used for axial tension performance test of the large-size fully-graded concrete axial tension specimen provided in Embodiment 1, and includes:

a loading base 16, wherein the loading base 16 is fixed on a rigid base by a base fixing bolt 17; a base ball joint 15 is embedded in a center of the loading base 16, and a connecting rod of the base ball joint 15 extends to an outer side of the loading base and is in threaded connection with an embedded threaded rod 3 of the large-size fully-graded concrete axial tension specimen;

a combined sleeve 10, wherein a first end of the combined sleeve 10 is in threaded connection with another embedded threaded rod 3 of the large-size fully-graded concrete axial tension specimen;

a load sensor 9, wherein the load sensor 9 is connected to a second end of the combined sleeve 10;

a tensile ball joint 8, wherein a ball seat of the tensile ball joint 8 is connected to the load sensor 9, and a connecting rod of the tensile ball joint 8 is connected to a tensile testing machine;

a displacement meter mounting frame 13, wherein the displacement meter mounting frame 13 is sleeved on an outer side of the specimen body 12 and is clamped and fixed on the specimen body 12 by tightening bolts of the displacement meter mounting frame 13; and

a displacement meter 11, wherein the displacement meter 11 is mounted on the displacement meter mounting frame 13.

In this embodiment, the base fixing bolt 17 is preferably an M18 high-strength bolt.

In this embodiment, an upper part of the loading base 16 is a cylindrical steel barrel with a diameter of 300 mm, and a base ball joint 15 is embedded in the center. A center of the base ball joint 15 is provided with a threaded hole with a specification of M33.

The large-size fully-graded concrete axial tension performance testing device provided in this embodiment further includes a protective bracket 14, wherein the protective bracket 14 is sleeved outside the connecting rod of the base ball joint 15 and is fixedly connected to the loading base 16.

Specifically, the protective bracket 14 is fixedly connected to the loading base 16 by a plurality of M10 threaded steel rods. According to the large-size fully-graded concrete axial tension performance testing device provided in this embodiment, a ball joint is arranged at a connection of the large-size fully-graded concrete axial tension specimen to achieve central symmetric tension loading, and the load sensor and the displacement meter are arranged to acquire a stress-strain curve in the fully-graded concrete axial tension test.

The large-size fully-graded concrete axial tension performance testing device provided in this embodiment has the following technical effects:
(1) Tensile ball joints and base ball joints are configured at two ends to eliminate the influence of eccentric loading, ensure the uniformity of axial tensile, and avoid test errors caused by uneven stress distribution.
(2) The load sensor and displacement meter are integrated to monitor the load-displacement changes in real time and directly generate a stress-strain curve, thus providing reliable data for evaluating the axial tension constitutive relationship of concrete.
(3) The protective bracket design effectively prevents accidental breakage of the specimen or damage to the device, and ensures the safety of the test process.

### Embodiment 4

A large-size fully-graded concrete axial tension performance testing method includes the following steps:

S10: assembling the manufacturing mold for a large-size fully-graded concrete axial tension specimen provided in Embodiment 2, and placing the manufacturing mold in a casting and molding area of a large-size fully-graded concrete axial tension specimen; wherein

specifically, the assembling the manufacturing mold for a large-size fully-graded concrete axial tension specimen includes the following steps:

S11: placing a slab in a casting and molding area of the large-size fully-graded concrete axial tension specimen;

S12: fixing a bottom side plate and edge side plates on the slab by first base fixing bolts; fixing the two edge side plates by using side fixing bolts, and screwing the bolts to press and fix the bottom side plate between the two edge side plates;

S20: welding an embedded steel plate and an embedded threaded rod to form an embedded part, and placing the embedded part in the manufacturing mold for a large-size fully-graded concrete axial tension specimen, wherein the embedded threaded rod passes through a reserved hole in a bottom side plate; wherein

a distance between the embedded steel plate and the bottom side plate at a corresponding side is 150 mm.

S30: casting fully-graded concrete into the manufacturing mold for the large-size fully-graded concrete axial tension specimen, dismantling the manufacturing mold for a large-size fully-graded concrete axial tension specimen after curing for 3 days, and then curing to a testing age to form the large-size fully-graded concrete axial tension specimen provided in Embodiment 1;

S40: fixing a loading base in the large-size fully-graded concrete axial tension performance testing device provided in Embodiment 3 on a rigid base by a base fixing bolt; mounting a protective bracket on the loading base, and mounting a combined sleeve on one end of the large-size fully-graded concrete axial tension specimen embedded with a threaded rod at one side; hoisting a large-size fully-graded concrete axial tension specimen by the combined sleeve, and mounting a threaded steel rod embedded at another end of the large-size fully-graded concrete axial tension specimen into a central threaded hole of a base ball joint; wherein an upper part of the combined sleeve is connected to a load sensor, an upper part of the load sensor is connected to a tensile ball joint, and an upper part of the tensile ball joint is connected to a tensile testing machine; and

S50: starting the tensile testing machine to start fully-graded concrete axial tension performance test, and acquiring a load-displacement curve in the test process by a load sensor and a displacement meter to further acquire a stress-strain relationship curve of the fully-graded concrete axial tension performance test.

The large-size fully-graded concrete axial tension performance testing method provided in this embodiment has the following technical effects:
(1) From mold assembly, specimen casting, maintenance to test device mounting, the steps are clear and systematic, which reduces human operation errors and improves the repeatability of test results.
(2) After 3 days of initial curing, the side plates are removed and curing is continued until the test age, which is in accordance with the law of concrete strength development to ensure stable performance of the specimens.

The above description is merely preferred embodiments of the present invention, and is not intended to limit the technical scope of the present invention. As such, any minor amendments, equivalent changes and modifications made to the above embodiments according to the technical spirit of the present invention shall fall within the scope of the technical solutions of the present invention.

What is claimed is:

1. A large-size fully-graded concrete axial tension specimen, comprising:
a specimen body formed by casting a fully-graded concrete;
two embedded steel plates, wherein the two embedded steel plates are embedded in the specimen body, and the two embedded steel plates are arranged in parallel and opposite to each other; and
two embedded threaded rods, wherein the two embedded threaded rods are arranged in a one-to-one correspondence with the two embedded steel plates, a first end of each of the two embedded threaded rods is fixedly connected to a corresponding embedded steel plate, and a second end of each of the two embedded threaded rods extends to an outer side of the specimen body.

2. The large-size fully-graded concrete axial tension specimen according to claim 1, wherein a size of the specimen body is 450 mm×450 mm×900 mm.

3. The large-size fully-graded concrete axial tension specimen according to claim 2, wherein a center line of the specimen body in a length direction, a normal center line of the embedded steel plate and a center axis of the embedded threaded rod are collinear.

4. A manufacturing mold for manufacturing the large-size fully-graded concrete axial tension specimen according to claim 1, comprising:
a slab;
two edge side plates oppositely arranged, wherein the two edge side plates are respectively arranged at edges of the slab in a width direction, and an end of each of the two edge side plates adjacent to the slab is fixedly connected to the slab by a slab fixing bolt;
two bottom side plates oppositely arranged, wherein the two bottom side plates are respectively fixedly mounted at edges of the slab in a length direction and enclose a casting space with an open end together with the slab and the two edge side plates;
wherein the two bottom side plates are fixedly connected to the slab by slab fixing bolts, and the two ends of the two bottom side plates are fixedly connected to the two edge side plates by side plate fixing screws and nuts; and the two bottom side plates are provided with reserved holes adapted to the two embedded threaded rods.

5. The manufacturing mold according to claim 4, wherein the bottom side plate is fixedly connected to the two edge side plates by two side plate fixing screws, the two side plate fixing screws are arranged in parallel, and two ends of each of the two side plate fixing screws sequentially pass through a connecting flange of the bottom side plate and a corresponding edge side plate to cooperate with the nut; and a through hole on the bottom side plate adapted to the embedded threaded rod is arranged between the two side plate fixing screws.

6. A large-size fully-graded concrete axial tension performance testing device, configured for an axial tension performance test of the large-size fully-graded concrete axial tension specimen according to claim 1, and comprising:
a loading base, wherein the loading base is fixed on a rigid base by a base fixing bolt; a base ball joint is embedded in a center of the loading base, and a connecting rod of the base ball joint extends to an outer side of the loading base and is in a threaded connection with a first embedded threaded rod of the large-size fully-graded concrete axial tension specimen;
a combined sleeve, wherein a first end of the combined sleeve is in the threaded connection with a second embedded threaded rod of the large-size fully-graded concrete axial tension specimen;
a load sensor, wherein the load sensor is connected to a second end of the combined sleeve;
a tensile ball joint, wherein a ball seat of the tensile ball joint is connected to the load sensor, and a connecting rod of the tensile ball joint is connected to a tensile testing machine;
a displacement meter mounting frame, wherein the displacement meter mounting frame is sleeved on the outer side of the specimen body and is clamped and fixed on the specimen body by tightening bolts of the displacement meter mounting frame; and
a displacement meter, wherein the displacement meter is mounted on the displacement meter mounting frame.

7. The large-size fully-graded concrete axial tension performance testing device according to claim 6, further comprising a protective bracket, wherein the protective bracket is sleeved outside the connecting rod of the base ball joint and is fixedly connected to the loading base.

8. A large-size fully-graded concrete axial tension performance testing method, comprising the following steps:
S10: assembling a manufacturing mold, and placing the manufacturing mold in a casting and molding area of the large-size fully-graded concrete axial tension specimen, wherein the manufacturing mold comprises:
a slab;
two edge side plates oppositely arranged, wherein the two edge side plates are respectively arranged at edges of the slab in a width direction, and an end of each of the two edge side plates adjacent to the slab is fixedly connected to the slab by a slab fixing bolt;
two bottom side plates oppositely arranged, wherein the two bottom side plates are respectively fixedly mounted at edges of the slab in a length direction and enclose a casting space with an open end together with the slab and the two edge side plates;
wherein the two bottom side plates are fixedly connected to the slab by slab fixing bolts, and the two ends of the two bottom side plates are fixedly connected to the two edge side plates by side plate fixing screws and nuts; and the two bottom side plates are provided with reserved holes adapted to the two embedded threaded rods;
S20: welding the embedded steel plate and the embedded threaded rod to form an embedded part, and placing the embedded part in the manufacturing mold for the large-size fully-graded concrete axial tension specimen, wherein the embedded threaded rod passes through the reserved hole in the bottom side plate;
S30: casting the fully-graded concrete into the manufacturing mold for the large-size fully-graded concrete axial tension specimen, dismantling the manufacturing mold for the large-size fully-graded concrete axial tension specimen after curing for 3 days, and then curing to a testing age to form the large-size fully-graded concrete axial tension specimen according to claim 1;
S40: fixing a loading base in a large-size fully-graded concrete axial tension performance testing device on a rigid base by a base fixing bolt; mounting a protective bracket on the loading base, and mounting a combined sleeve on a first end of the large-size fully-graded concrete axial tension specimen embedded with the embedded threaded rod at a side; hoisting the large-size fully-graded concrete axial tension specimen by the combined sleeve, and mounting a threaded steel rod embedded at a second end of the large-size fully-graded concrete axial tension specimen into a central threaded hole of a base ball joint; wherein an upper part of the combined sleeve is connected to a load sensor, an upper part of the load sensor is connected to a tensile ball joint, and an upper part of the tensile ball joint is connected to a tensile testing machine, wherein the large-size fully-graded concrete axial tension performance testing device is configured for an axial tension performance test of the large-size fully-graded concrete axial tension specimen and comprises:
the loading base, wherein the loading base is fixed on the rigid base by the base fixing bolt; the base ball joint is embedded in a center of the loading base, and a connecting rod of the base ball joint extends to an outer side of the loading base and is in a threaded connection with a first embedded threaded rod of the large-size fully-graded concrete axial tension specimen;
the combined sleeve, wherein a first end of the combined sleeve is in the threaded connection with a second embedded threaded rod of the large-size fully-graded concrete axial tension specimen;
the load sensor, wherein the load sensor is connected to a second end of the combined sleeve;
the tensile ball joint, wherein a ball seat of the tensile ball joint is connected to the load sensor, and a connecting rod of the tensile ball joint is connected to the tensile testing machine;
a displacement meter mounting frame, wherein the displacement meter mounting frame is sleeved on the outer side of the specimen body and is clamped and fixed on the specimen body by tightening bolts of the displacement meter mounting frame; and
a displacement meter, wherein the displacement meter is mounted on the displacement meter mounting frame; and
S50: starting the tensile testing machine to start a fully-graded concrete axial tension performance test, and acquiring a load-displacement curve in a test process by the load sensor and the displacement meter to further acquire a stress-strain relationship curve of the fully-graded concrete axial tension performance test.

9. The large-size fully-graded concrete axial tension performance testing method according to claim 8, wherein the assembling the manufacturing mold in the step S10 comprises the following steps:
S11: placing the slab in the casting and molding area of the large-size fully-graded concrete axial tension specimen;
S12: fixing the bottom side plate and the two edge side plates on the slab by bolts; fixing the two edge side plates by using side fixing bolts, and screwing the bolts to press and fix the bottom side plate between the two edge side plates;
in the step S20, a distance between the embedded steel plate and the bottom side plate at a corresponding side is 150 mm.

10. The manufacturing mold according to claim 4, wherein in the large-size fully-graded concrete axial tension specimen, a size of the specimen body is 450 mm×450 mm×900 mm.

11. The manufacturing mold according to claim 10, wherein in the large-size fully-graded concrete axial tension specimen, a center line of the specimen body in a length direction, a normal center line of the embedded steel plate and a center axis of the embedded threaded rod are collinear.

12. The large-size fully-graded concrete axial tension performance testing device according to claim 6, wherein in the large-size fully-graded concrete axial tension specimen, a size of the specimen body is 450 mm×450 mm×900 mm.

13. The large-size fully-graded concrete axial tension performance testing device according to claim 12, wherein in the large-size fully-graded concrete axial tension specimen, a center line of the specimen body in a length direction, a normal center line of the embedded steel plate and a center axis of the embedded threaded rod are collinear.

14. The large-size fully-graded concrete axial tension performance testing method according to claim 8, wherein in the large-size fully-graded concrete axial tension specimen, a size of the specimen body is 450 mm×450 mm×900 mm.

15. The large-size fully-graded concrete axial tension performance testing method according to claim 14, wherein in the large-size fully-graded concrete axial tension specimen, a center line of the specimen body in the length direction, a normal center line of the embedded steel plate and a center axis of the embedded threaded rod are collinear.

16. The large-size fully-graded concrete axial tension performance testing method according to claim 8, wherein in the manufacturing mold, the bottom side plate is fixedly connected to the two edge side plates by two side plate fixing screws, the two side plate fixing screws are arranged in parallel, and two ends of each of the two side plate fixing screws sequentially pass through a connecting flange of the bottom side plate and a corresponding edge side plate to cooperate with the nut; and a through hole on the bottom side plate adapted to the embedded threaded rod is arranged between the two side plate fixing screws.

17. The large-size fully-graded concrete axial tension performance testing method according to claim 8, wherein the large-size fully-graded concrete axial tension performance testing device further comprises the protective bracket, wherein the protective bracket is sleeved outside the connecting rod of the base ball joint and is fixedly connected to the loading base.

18. The manufacturing mold according to claim 10, wherein the bottom side plate is fixedly connected to the two edge side plates by two side plate fixing screws, the two side plate fixing screws are arranged in parallel, and two ends of each of the two side plate fixing screws sequentially pass through a connecting flange of the bottom side plate and a corresponding edge side plate to cooperate with the nut; and a through hole on the bottom side plate adapted to the embedded threaded rod is arranged between the two side plate fixing screws.

19. The manufacturing mold according to claim 11, wherein the bottom side plate is fixedly connected to the two edge side plates by two side plate fixing screws, the two side plate fixing screws are arranged in parallel, and two ends of each of the two side plate fixing screws sequentially pass through a connecting flange of the bottom side plate and a corresponding edge side plate to cooperate with the nut; and a through hole on the bottom side plate adapted to the embedded threaded rod is arranged between the two side plate fixing screws.

20. The large-size fully-graded concrete axial tension performance testing device according to claim 12, further comprising a protective bracket, wherein the protective bracket is sleeved outside the connecting rod of the base ball joint and is fixedly connected to the loading base.
